(19) United States
(12) Patent Application Publication
(10) Pub. No.: US 2010/0048342 A1
(43) Pub. Date: Feb. 25, 2010

(54) Rotary transmission

(76) Inventor: Richard Chadwick, Halesowen (GB)

Correspondence Address: FLYNN THIEL BOUTELL & TANIS, P.C., 2026 RAMBLING ROAD, KALAMAZOO, MI, 49008-1631, US

(21) Appl. No.: 11/989,645

(22) PCT Filed: Jul. 31, 2006
(86) PCT No.: PCT/GB2006/002842

§ 371 Date: Oct. 1, 2009

(30) Foreign Application Priority Data
Jul. 30, 2005 (GB) 0515729.2
Mar. 8, 2006 (GB) 0604623.9

(51) Int. Cl. F16H 1/32

(52) U.S. Cl. 475/181

(57) ABSTRACT

An apparatus for transmission of rotation between a first rotational member and a second rotational member comprises a first gear member mounted for rotation about an axis and coupled for rotation to the first rotational member. An eccentric gear arrangement is mounted eccentrically with respect to the axis and has a first eccentric gear portion for engagement with the first gear member and a second eccentric gear portion for engagement with a second gear member. Crank means couple the eccentrically mounted gear arrangement to the second rotational member, whereby orbital motion of the eccentric gear arrangement about the axis is transmitted to the second rotational member. The first and second eccentric gear portions are coupled for rotation with each other, and the first and second gear members are rotationally independent of each other.

The present invention relates to the transmission of rotational motion in mechanisms. More particularly it relates to an improved gear mechanism for use in gearboxes operating as either a speed increaser or a speed decreaser.

Gearbox design is particularly important in the field of wind power generation. Many of the problems with present designs of wind turbine generating systems are attributable to gearboxes that couple the generator, rotating at typically 1500 rpm (for some 750 rpm is common, for some up to 3300 rpm is common), to the rotor, which rotates at typically about 20 to 50 rpm. This is traditionally accomplished by stages through multiple gear ratios using convolute gear arrangements. However, these gearboxes are not efficient and suffer from reliability problems. They are also heavy, expensive and noisy due to the large number of moving components.

It is known to use epicyclic speed reduction gearboxes. One such design utilises cycloid discs that operate on the principles of Ferguson's paradox. An input shaft drives an eccentric cam to orbit the cycloid discs around the internal circumference of a stationary ring gear. For each complete rotation of the eccentric cam, the cycloid disc is rotated through a small angle in the reverse direction in accordance with Ferguson's paradox. This slow counter-rotation of the cycloid discs is transmitted to an output shaft to produce a speed reduction. In one example the speed reduction ratio is 119:1.

It is an object of the present invention to provide an improved rotary transmission mechanism.

According to a first aspect of the present invention there is provided an apparatus for transmission of rotation between a first rotational member and a second rotational member, the apparatus comprising:

a first gear member mounted for rotation about an axis and coupled for rotation to said first rotational member;

an eccentric gear arrangement mounted eccentrically with respect to said axis and having a first eccentric gear portion for engagement with said first gear member and a second eccentric gear portion for engagement with a second gear member, and

crank means coupling said eccentrically mounted gear arrangement to said second rotational member, whereby orbital motion of said eccentric gear arrangement about said axis is transmitted to said second rotational member, wherein:

said first and second eccentric gear portions are coupled for rotation with each other, and

said first and second gear members are rotationally independent of each other.

In a preferred embodiment, the first rotational member is an input shaft, and the second rotational member is an output shaft.

It should be understood that it is not necessary for the gears to be provided with teeth having any particular profile or form. Moreover, it is not necessary for there to be any particular number of gear teeth, or even for these to be equi-spaced around the gears, provided that, in their orbital motion, the eccentric gears are caused to rotate about their eccentric axis as a result of engaging with the corresponding gear members. It should be further understood that the term crank means is not intended to refer to any particular form of such mechanism, but refers to any means whereby rotation is transmitted between the second rotational member and the orbital motion of the eccentric gear arrangement. Indeed, one exemplary embodiment employs a simple arrangement of co-joined external profile gears; this gear pair may take the form of a single gear member of one diameter and having the same number and profile of teeth on each portion.

It is an advantage that the invention allows a very substantial increase in rotational speed to be achieved with the use of a simple gear arrangement having a minimal number of component parts. For these reasons an apparatus of this configuration is particularly suitable for coupling a wind turbine to a generator.

In one embodiment the first gear member is an internally-toothed gear, and the first eccentric gear portion is an externally-toothed gear. The second gear member may be an internally-toothed gear, and the second eccentric gear portion an externally-toothed gear. Alternatively, the second gear member may be an externally-toothed gear, and the second eccentric gear portion an internally-toothed gear.

In one embodiment, the first gear member is an externally-toothed gear, and the first eccentric gear portion is an externally-toothed gear. The second gear member may be an internally-toothed gear, and the second eccentric gear portion an externally-toothed gear. Alternatively, the second gear member may be an externally-toothed gear, and the second eccentric gear portion an internally-toothed gear or an externally-toothed gear.

In one embodiment, the first gear member is an externally-toothed gear, and the first eccentric gear portion is an internally-toothed gear. The second gear member may be an internally-toothed gear, and the second eccentric gear portion an externally-toothed gear. Alternatively, the second gear member may be an externally-toothed gear, and the second eccentric gear portion an internally-toothed gear or an externally-toothed gear.

Embodiments of the invention may include gearboxes wherein the second gear member is fixed to the body or casing of the gearbox. Alternatively, the second gear member may be free to rotate or may be driven to rotate.

Preferably, the first and second eccentric gear portions have profiles that mesh with corresponding profiles on the first and second gear members. More preferably the profiles are of a toothed, cycloidal or sinusoidal profile. Conveniently, the number of such profiles or teeth on each of said eccentric gear portions and gear members are selected to provide a predetermined speed increase or reduction ratio. For example, the number of teeth on the first eccentric gear portion may be one less than the number of teeth on the first gear member (and likewise for the second eccentric gear portion and second gear member). The number of teeth on the first gear member is preferably different to the number of teeth on the second gear member. Alternatively, or additionally, the number of teeth on the first eccentric gear portion may be different to the number of teeth on the second eccentric gear portion.

The first and second eccentric gear portions may be rigidly connected to one another. Alternatively, the first and second eccentric gear portions may be coupled to each other by way of a rigid, semi-rigid, or flexible coupling. In an alternative embodiment a ratchet mechanism may be employed such that the first and second eccentric gear portions are coupled for rotation in one direction, but not in the other (reverse) direction. For example, an application where the use of a ratchet coupling is advantageously employed is one used to generate rotational motion in a reciprocating system—such as in a wave energy system. A further example envisaged is to recover air energy generated through the motion of a moving vehicle. For example, an axial fan may be connected through the gearbox to a generator. The axial fan may be mounted on the vehicle as an accessory, or built in at the factory where it may be placed in a concealed position—e.g. on the underside of a vehicle.

Embodiments of the invention may further comprise means for balancing the apparatus. The means for balancing may comprise a balance mass attachable to the second rotational member. In a preferred embodiment the first and/or second eccentric gear portions are provided with annular cut-outs to accommodate the balance mass.

Alternatively, the balancing means may comprise a further gear portion mounted to said second rotational member for rotation about an offset axis. The second rotational member may include a portion with an extended crank radius such that the further gear portion is mounted for rotation as a planet gear. The balancing means may comprise a plurality of planet gears. The masses of the planet gears, the crank radius of the crankshaft portion and the angular positions of the planet gears may be selected or altered to facilitate balancing.

According to a second aspect of the present invention there is provided an apparatus for transmission of rotation between a first rotational member and a second rotational member, the apparatus comprising:

a first internal gear mounted for rotation about an axis and coupled for rotation to said first rotational member;

an external gear arrangement mounted eccentrically with respect to said axis and having a first gear portion for engagement with said first internal gear and a second gear portion for engagement with a second internal gear, and

crank means coupling said eccentrically mounted external gear arrangement to said second rotational member, whereby orbital motion of said eccentrically mounted external gear arrangement about said axis is transmitted to said second rotational member,

wherein:

said first and second external gear portions are coupled for rotation with each other, and

said first and second internal gears are rotationally independent of each other.

Embodiments of the invention will now be described with reference to the accompanying drawings, in which:

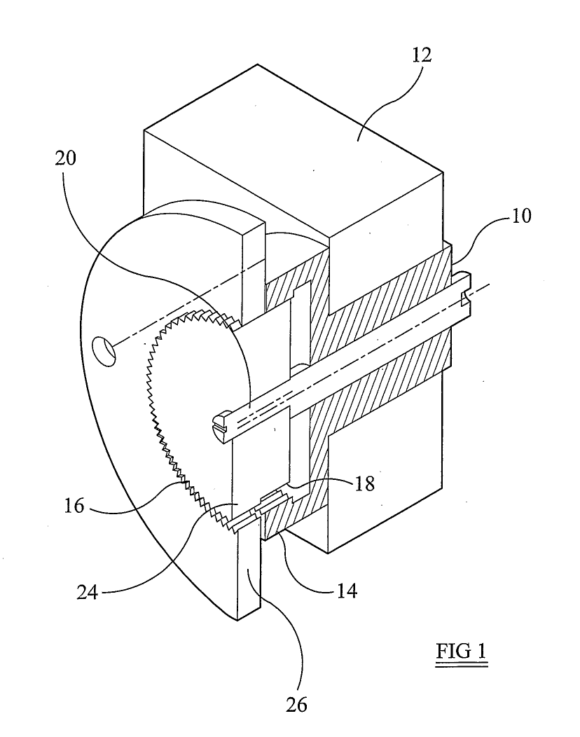

FIG. 1 is a perspective view of a half-section of a rotary transmission system in accordance with the invention;

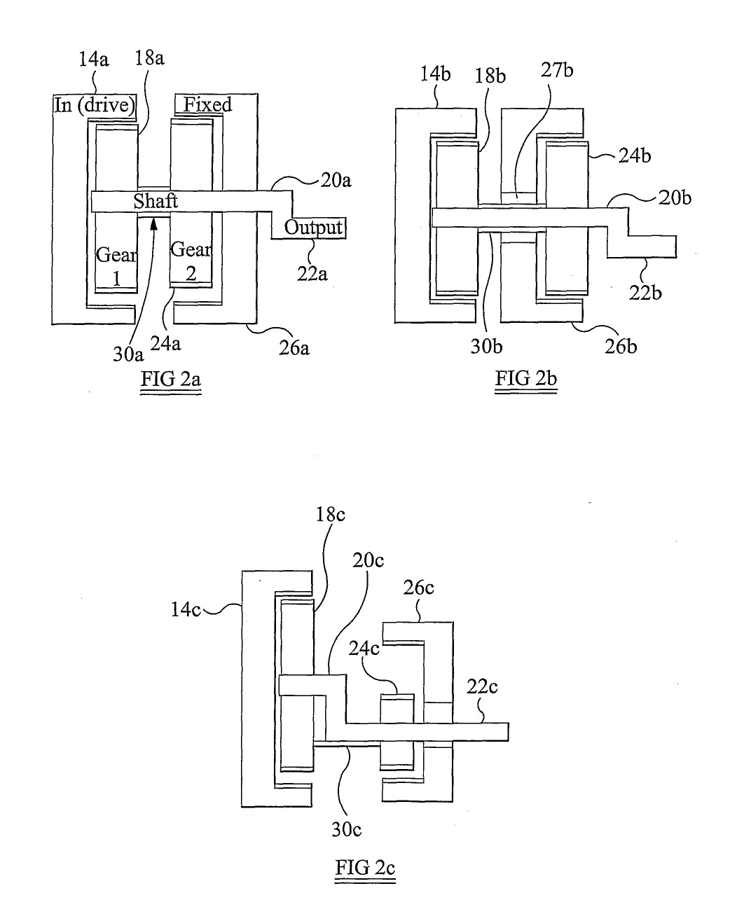

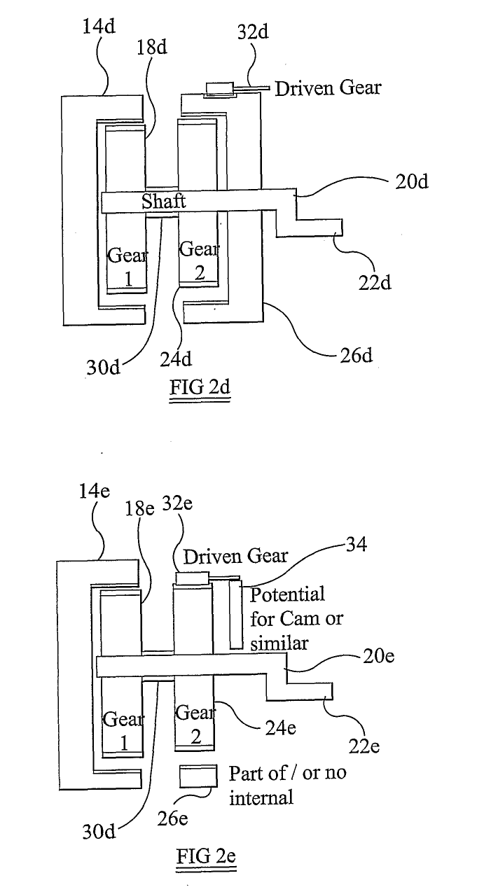

FIGS. 2a to 2e illustrate a variety of gear arrangements in accordance with the present invention;

FIGS. 3a to 3c illustrate methods of assembling gears onto a crank-shaft for use in a transmission system of the invention;

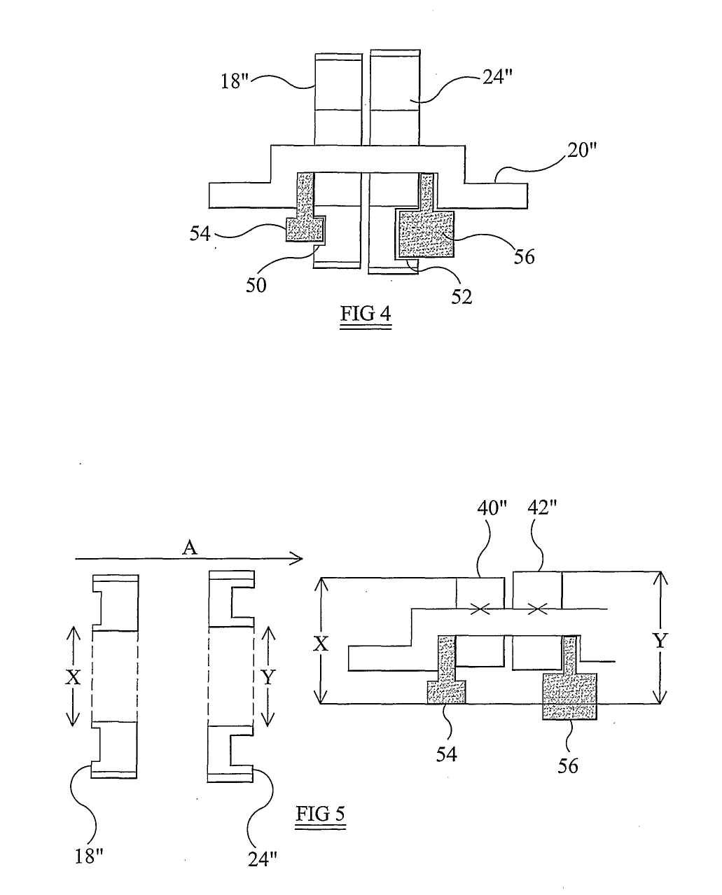

FIG. 4 illustrates an arrangement of gears and balance weights forming part of a transmission system according to the invention;

FIG. 5 illustrates a method of assembling the gears and balance weights of FIG. 4 onto a crank-shaft;

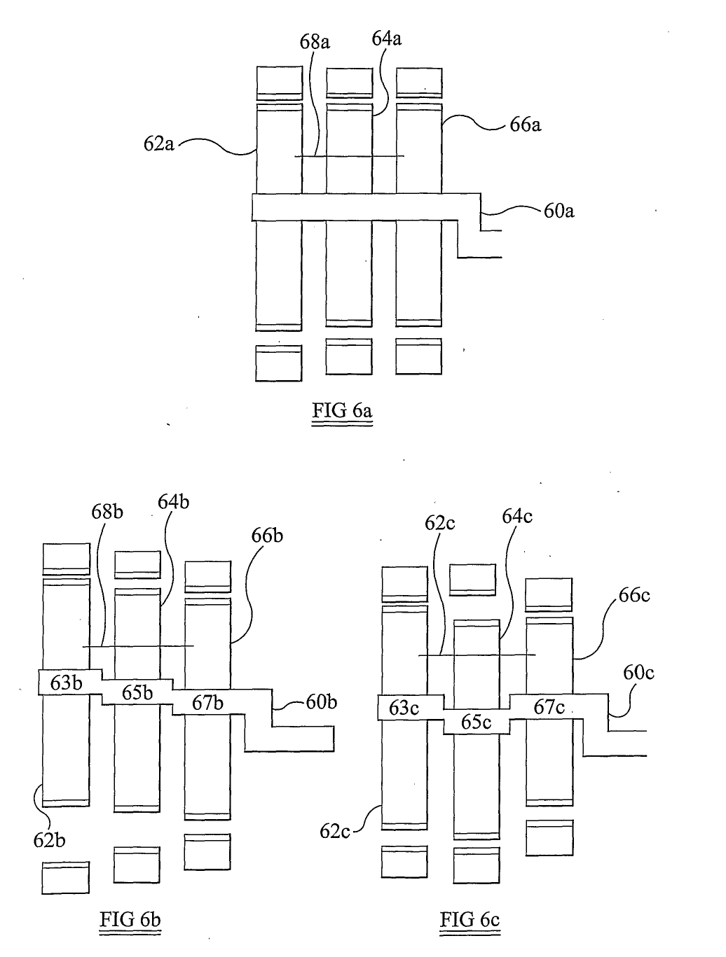

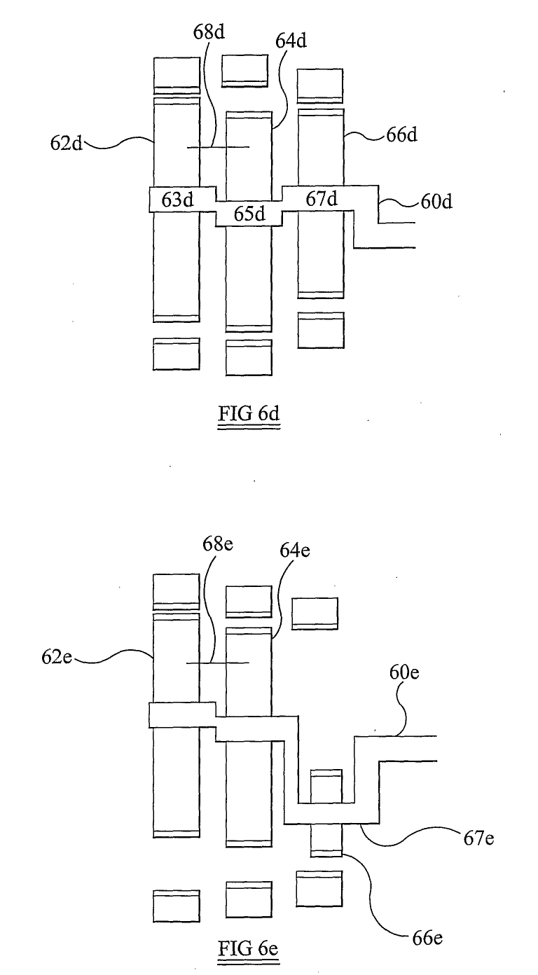

FIGS. 6a to 6e illustrate further gear arrangements in accordance with embodiments of the invention; and

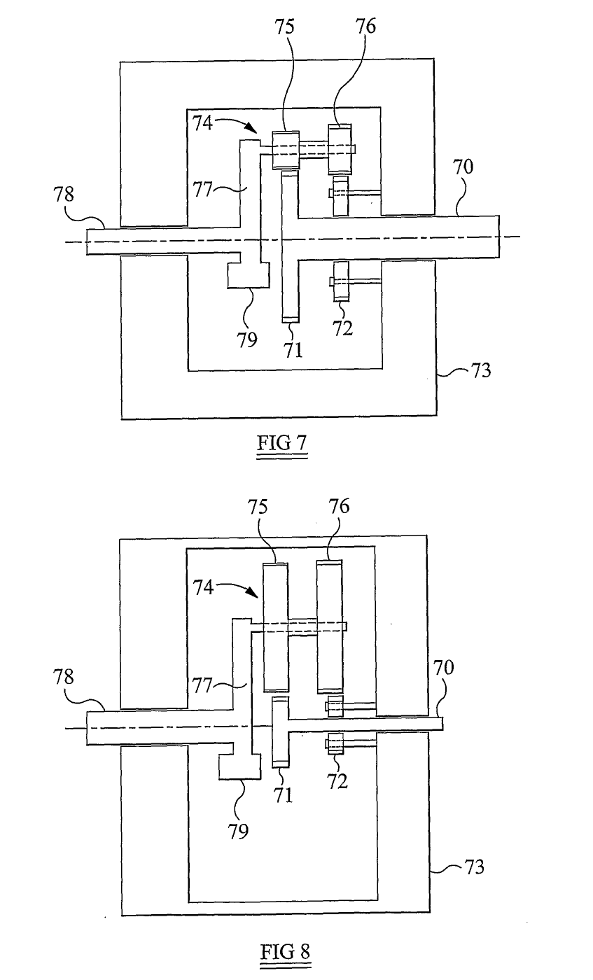

FIG. 7 to 13 illustrate gear arrangements in accordance with further embodiments.

Referring to FIG. 1, a first rotational member in the form of a hollow shaft 10 is mounted for rotation in a bearing block 12. The hollow shaft 10 carries a first internal gear 14. An external gear arrangement 16 includes a first external gear portion 18, which engages the first internal gear 14. The external gear arrangement is mounted for rotation about an axis defined by a crank member 20, which extends from a second rotational member in the form of a solid shaft 22. The solid shaft 22 is mounted for rotation coaxially with and internally of the hollow shaft 10. The crank member 20 has an axis, which is off-set relative to that of the solid shaft 22 so that the external gear arrangement rotates eccentrically (i.e. orbits) within the first internal gear 14. A second external gear portion 24 of the external gear arrangement 16 engages a second internal gear 26.

Although rotary transmission systems in accordance with the invention may be used both for increasing and reducing speed, the principles of the operation of the apparatus may best be understood by considering a transmission of rotation provided at the second rotational member 22 to provide a speed reduction. When rotation is provided to the solid shaft 22, the crank member 20 causes the eccentrically mounted external gear arrangement 16 to be driven in an orbital motion. As its does so, the second gear portion 24 engages the inside of the second internal gear 26 (assume for the present that this second internal gear 26 is fixed). As it orbits in, say, a clockwise direction, the eccentric external gear arrangement 16 itself undergoes a slow anticlockwise rotation. That is to say that, for every complete clockwise orbit, the second external gear portion 24 is rotated by a small angle in the anticlockwise direction. This phenomenon is known as Ferguson's paradox. The anticlockwise rotation can be transmitted to provide an output having a substantial reduction in rotational speed. Gearboxes, particularly speed-reduction gearboxes, operating on this principle are known in the art.

However, in the present invention, the onward transmission of rotation to the first rotational member 10 is by way of the first external gear portion 18 engaging the first internal gear 14. Because this arrangement is itself an orbital motion of an eccentric within an internal gear, it has its own natural reverse rotation in accordance with Ferguson's paradox, although in this case the first internal gear 14 is not fixed. If the gear tooth ratios of the first gear pair (first internal gear 14 and first gear portion 18 of the external gear arrangement 16) and the second gear pair (second internal gear 26 and second gear portion 24 of the external gear arrangement 16) were the same, in this scenario the motion of the gear 14 would be subject to a single gear ratio. However, with different gear ratios in the first and second gear pairs, the orbital motion of the first gear portion 18 of the eccentric external gear 16 will cause the first internal gear 14 to rotate at a compounded gear ratio (at a very low speed).

Because the first and second external gear portions are rotationally coupled (in the embodiment of FIG. 1 they are formed of a single block of material), the rotational constraints of one are fed-back to the other. This means that the Ferguson paradox reverse rotation is a function of the constraints of both gear pairs, and the overall speed reduction ratio is many times that of known epicyclic gear arrangements.

It will be appreciated that the principle described above applies equally in reverse, so that a substantial increase in rotational speed can be produced when the input is provided at the first rotational member 10. Rotation of the input shaft may be used to drive the first internal gear 14. The eccentrically mounted external gear arrangement 16 will be driven into an orbital motion. The orbital motion is transmitted to the output shaft 22 by way of the crank means 20. In this scenario, the first and second internal gears 14, 26 and/or the first and second gear portions 18, 24 of the external gear arrangement 16 may have the same number and profile of teeth, or may have different teeth ratios. The first internal gear 14 is driven by the input shaft 10, while the second internal gear 26 is fixed (or driven at a different speed). This sets up a compound gear ratio between the input and output, giving rise to a very large increase in rotational speed.

This means that, for example, a gearbox operating on the above principles (primarily the compound ratio) can be used to provide an increase in speed with a ratio of 1:1000 or more. Such a gearbox has very few components when compared with more conventional known gear arrangements for providing a comparable speed increase. The low number of components means that reliability is less likely to cause a problem, and also reduces frictional losses. A gearbox of this type has many benefits in applications such as speed increase in wind turbine generators.

Although the invention has been explained above with reference to FIG. 1, in which the gears are shown having a recognisable tooth profile, it should be understood that it is not necessary for the teeth to have any particular profile or form. Indeed, an involute gear tooth profile, as used in many conventional gear arrangements, may not be preferred in applications of the present invention. Known epicyclic gearboxes employ altogether different tooth profiles. One example is a curved cycloidal profile on the eccentric gear (cycloid disc) that engages with rollers on the internal gear, on the epicyclic speed reduction gearbox described above. This produces a smooth progressive rolling action of the cycloid disc, which has very low friction and substantially eliminates the pressure points found in conventional involute gears. Moreover, it is not necessary for the application of the principles of the present invention for there to be any particular number of gear teeth, or even for these to be equi-spaced around the gears. Provided that, in their orbital motion, the eccentric external gears engage with the corresponding internal gears such that they are caused to rotate about their eccentric axis, then the principles will still apply.

In an exemplary embodiment, the first internal gear 14 has 80 teeth and the second internal gear 26 has 81 teeth, while the first external gear portion 18 has 73 teeth and the second external gear portion 16 has 72 teeth. This arrangement will provide an overall gear ratio between the input and the output of 1:730 (or 730:1 when used as a speed reducer). Theoretically ratios of 10,000:1 may be possible. However, in practice there may be a minimum limit on the tooth difference between gear pairs of about 10% of the number of teeth. Realistically, ratios of 1600:1 are readily achievable. This compares with typical speed reduction ratios of around 100:1 in the known epicyclic speed reduction mechanism using a cycloid gear, as described above.

In an exemplary embodiment, the first internal gear 14 has 77 teeth and the second internal gear 26 has 78 teeth, while the first external gear portion 18 has 69 teeth and the second external gear portion 16 has 70 teeth. This arrangement will provide an overall gear ratio between the input and the output of 1:674 (or 674:1 when used as a speed reducer). Theoretically ratios of 10,000:1 may be possible. However, in practice there may be a minimum limit on the tooth difference between gear pairs of about 10% of the number of teeth. Realistically, ratios of 1600:1 are readily achievable. This compares with typical speed reduction ratios of around 100:1 in the known epicyclic speed reduction mechanism using a cycloid gear, as described above.

Referring to FIG. 2a, an alternative arrangement is shown, in which (for a speed increase application) a first internal gear 14a is provided with a rotational drive from a first rotational member (not shown). First and second external gears 18a, 24a are coupled by way of a crank 20a to an output shaft 22a. Here the input drive and the output are arranged at opposite sides, but in other respects the operation is the same as described above with reference to FIG. 1.

In FIG. 2a the two eccentric external gears 18a, 24a are shown as separate gear wheels connected by a coupling 30. Because the two external gear portions 18a, 24a will, in general, have a different number of gear teeth (or profiled sections), it is more convenient to manufacture these as two separate components. The coupling 30 may be a rigid connection (for example by way of the crank member 20a) or a flexible coupling (such as an Oldham coupling). Alternatively, the coupling 30a could be a ratchet mechanism such that the two external gear portions 18a, 24a are coupled for rotation in one direction, but are free to rotate relative to one another in the opposite direction.

In the embodiment shown in FIG. 2b, a similar arrangement to that of FIG. 1a is shown, but in this case the second internal gear 26b is mounted between the first and second external gear portions 18b, 24b. The coupling 30b extends through a hub region 27b of the second internal gear 26b.

In the embodiment shown in FIG. 2c, the crank means 20c is disposed between the first and second external gear portions 18c, 24c. The second external gear portion 24c rotates independently of the output shaft 22c as it orbits inside the second internal gear 26c. However, the coupling 30c between the first external gear portion 18c and the second external gear portion 24c is by way of a ratchet-type mechanism, in which one portion is driven to rotate in one direction only by rotation of the other portion. This coupling may be arranged to engage and disengage intermittently as one of the gear portion rotates relative to the other.

Referring to FIG. 2d, another arrangement is shown similar to that of FIG. 2a, except that second internal gear is not fixed, but is independently driven by way of a separate drive gear 32d that engages teeth on an exterior surface. The second internal gear may be driven at a fixed or variable speed by an independent servo drive, for example an electric motor. Alternatively the servo drive may be taken off either the input or the output of the gear arrangement.

FIG. 2e shows a variation of the arrangement of FIG. 2d, in which the second external gear portion is driven directly from a servo drive 32e. In the shown embodiment, In order to maintain a drive throughout the orbital motion of the second external gear portion 24e, the servo drive 32e is mounted off a cam arrangement, which reciprocates as the crank member 20e rotates around the axis of the output shaft 22e, although other embodiments may be envisaged.

Clearly the rotational speed ratios between the input and the output will depend on the precise arrangement used. In particular, for the arrangements shown in FIGS. 2d and 2e, the speed ratio will depend on the speed at which the second internal gear 26d, or the second external gear portion 24e is driven.

It will be appreciated that the principles of rotary transmission according to the present invention may be incorporated into a gearbox. The gearbox may comprise any of the arrangements of gears described above, either alone or in combination with other gear arrangements. For example, the mechanism of the present invention may be used in combination with a conventional, planetary or other gear arrangement. For some embodiments, the gears are preferably manufactured from a plastics material, which provides a relatively lightweight, quiet and low friction mechanism. Other components may also be formed of plastics or of a suitable metal.

The embodiments described above and illustrated in FIGS. 1 and 2a to 2e, show the gear portions mounted on an end of the crankshaft 20. In other words the gears are supported in a cantilevered arrangement, with the weight supported by crankshaft bearings disposed on one side of the gears. In some circumstances it may be preferable for the crankshaft carrying the gear portions to be supported on bearings at either side of the gears. Various methods may be used to mount the gears to the shaft, for example having a split shaft with a central coupling, or having split gear portions. FIGS. 3a to 3c illustrate another method of mounting gear portions 18′, 24′ onto a crankshaft 20′, which is configured to be supported on bearings at each end. A pair of split bushes 40, 42 are each mounted to the crankshaft 20′. The split bushes 40, 42 each have an outer diameter corresponding to an inner journal diameter of one of the gear portions 18′, 24′. Accordingly the gear portions 18′, 24′ can be slid over the crank shaft in the direction of arrow A and over the corresponding split bush 40, 42, to arrive at the configuration shown in either FIG. 3b or FIG. 3c.

In FIG. 3b, the split bushes 40, 42 are mounted by means of a key/keyway engagement 44, for rotation with the crankshaft 20′. It will be appreciated that since the gear portions 18′, 24′ rotate around the split bushes 40, 42, these may be provided as a single, or integral split bush that supports both the gear portions, as shown in FIG. 3b

In FIG. 3c, the split bushes 40, 42 are free to rotate on the crankshaft 20′ and are fixed for rotation with their corresponding gear portion 18′, 24′ by means of a corresponding key/keyway 46, 48 or by a toothed engagement. It will be appreciated that, since the two gear portions 18′ 24′ are coupled for rotation with each other, the two split bushes 40, 42 may be a single, or integral split bush.

The use of eccentric gears in the rotary transmission arrangements described, means that a practical transmission system should require balancing. This may be performed by assembling components to the respective input and output shafts and performing a static balance. One way to do this is to mount an eccentric balancing mass to the crankshaft. An example is shown in FIG. 4. Here the external gears 18″, 24″ are shown with a corresponding annular cut-out 50, 52. Balancing counter-weights 54, 56 are affixed to the crankshaft 20″ such that these extend into the cut-outs 50, 52 as shown.

An advantage of this arrangement is that the moving mass of the system is reduced (due to material being removed from the gear portions 18″, 24″ to form the cut-outs 50, 52), but it also enables the counter-weights 54, 56 to be positioned within the gear envelope, and hence closer to the required balance points.

Other setups can also be envisaged, such as a different number of static balance counter-weights, fixed or appended to the crankshaft 20″, or driven separately, such as by a separate parallel shaft provided for the purpose of balancing and driven from the input shaft. Also the balance mass can be shaped to suit, and does not have to be fixed within the gear envelope.

Assembly of the gear portions 18″, 24″ over the balance counter-weights 54, 56 follows a procedure similar to that described above with reference to FIGS. 3a to 3c, and illustrated in FIG. 5. The only difference is that the split bushes 40″, 42″ and journals in the gear portions 18″, 24″ must be sized to allow these to pass over the smaller of the balance counter-weights 54, as indicated by the respective dimensions X and Y (X and Y might be the same if there is enough clearance for gear portion 24″ to pass over the split bush 42″, once it has cleared the counter-weight 54).

Referring to FIGS. 6a to 6e, it will be appreciated that the principles of the present invention are not limited to gear arrangements having just two gear portions. FIG. 6a shows an arrangement that includes three gear portions 62a, 64a, 66a, mounted on a crankshaft 60a. As shown schematically by the line 68a, the three gear portions 62a, 64a, 66a are coupled for rotation with each other. As shown in FIG. 6b, the gear portions 62b, 64b, 66b may be mounted on respective portions 63b, 65b, 67b, of the crankshaft 60b, each portion having a different crank arm or radius. This is another way that the different gear portions 62b, 64b, 66b may be arranged to provide different gear speed ratios in a single gearbox (in addition to varying the number of gear teeth and/or gear diameters as well as varying which ‘gear/s’ is/are fixed and which ‘gear/s’ is/are the off-take/s).

Another arrangement is illustrated in FIG. 6c for gear portions 62c, 64c, 66c mounted on respective crankshaft portions 63c, 65c, 67c of crankshaft 60c.

As shown in FIG. 6d, it is not necessary for all the gear portions to be coupled for rotation with each other. Here only the first two gear portions 62d, 64d are coupled (as indicated by the line 68d). The third gear portion 66d is mounted so as to move independently. This arrangement will provide a different gear ratio for the third gear portion 66d, compared to the arrangement shown in FIG. 6c. This arrangement may be particularly useful to aid static balancing of the gearbox. The third gear portion may be selected to have a mass, and an axis of rotation, which is offset so as to balance the eccentric masses of the first and second gear portions 62d, 64d.

The principle described above in relation to FIG. 6d, may be taken further in the example shown in FIG. 6e. Here the crankshaft 60e includes a portion 67e with an extended crank radius so that the third gear portion 66e is mounted for rotation in the manner of a planet gear. (Note that the gear portion 66e moves around the internal profile of an internal gear, in the same manner as the gear portion 66d in FIG. 6d, in which case both gear portions 66d, 66e might be considered as moving in the manner of a planet gear—in both cases the gear portion may be used to help balance the system.) It is also possible to include more than one planet gear wheel 66e at different angular positions. The masses of the planet gears 66e, the crank radius of the crankshaft portion 67e, and the angular positions can be selected or altered to allow balancing of the gear arrangement.

In the embodiments described above, the eccentric gear arrangements are all external gears, while the gear members that engage the eccentric gear portions are internal gears. The principles of the present invention may be extended to other arrangements. In the embodiment shown in FIG. 7, an first external gear member 71 is mounted for axial rotation on an input shaft 70. A second external gear member 72 is fixed to the gearbox casing 73. An eccentric gear arrangement 74 includes a first external eccentric gear portion 75, which is driven by the first gear member 71, and is coupled for rotation with a second external eccentric gear portion 76, which engages the fixed second gear member 72. The eccentric gear arrangement 74 rotates on an eccentric axis defined by a crank arm 77 linked to an output shaft 78. the eccentric gear arrangement 74 is balanced by a counterbalance weight 79.

As with the earlier-described embodiments, the second external gear member 72 may be free to rotate, or may be driven.

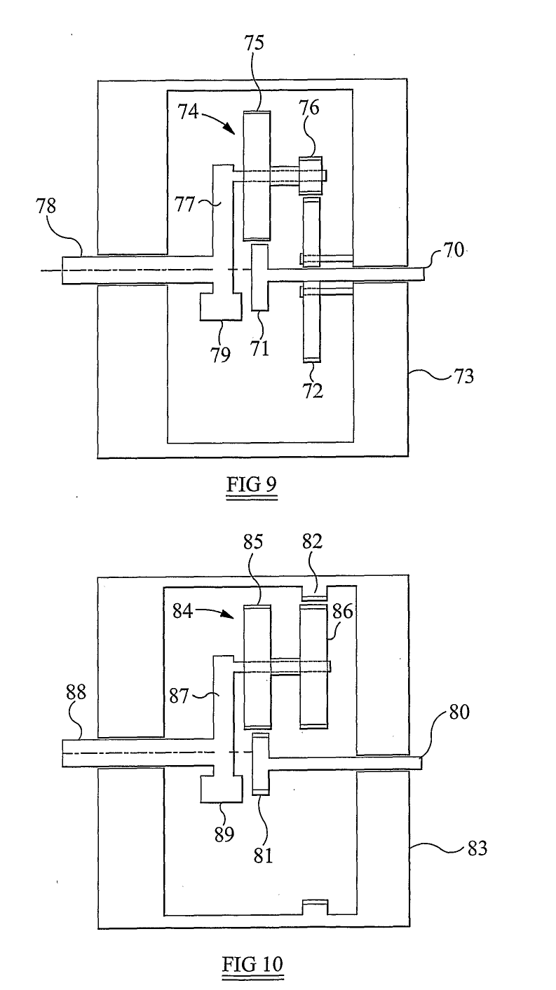

FIGS. 8 and 9 show two variations of the arrangement of FIG. 7, in which the same reference numerals are used for the equivalent components. In these variations, the relative diameters (and therefore the gear ratios) of the various external gears are different. In FIG. 8 the first gear member 71 has a smaller diameter, and the first eccentric gear portion 75 has a larger diameter. In FIG. 9, both the first and second gear members 71, 72 have smaller diameters, while both the first and second eccentric gear portions have larger diameters.

In the manufacture of gears, it is generally desirable, where possible to use involute gear profiles, because these are plentiful and much easier to obtain or manufacture than other gear profiles. Also, any involute gear tooth of a given size will mesh with any other equivalent sized involute gear tooth. When involute gear teeth engage one another, there is a contact angle between the teeth surfaces of around 17 to 20 degrees. When the contact angle is in the right direction, this provides a rolling contact between the gear teeth. However, if the contact angle is in the wrong direction, this can give rise to locking between meshing involute gears. The problem of locking can arise when meshing an eccentric or planet gear with another external gear if the gear ratio between the driving gear member and the eccentric gear is too large. This is one reason why many designs of epicyclic gear arrangements avoid the use of involute gears.

However, the gear arrangements shown in FIGS. 8 and 9 overcome this problem by using the principles of the invention, in combination with a reduced gear ratio between the first and second gear members 71, 72 and the eccentric gears 75, 76. This means that an effective overall gear ratio (say 10:1 or more) can be achieved in a gear box that uses only involute gears. In the embodiment of FIG. 9, when input torque is provided at the input shaft 70, this is always transmitted from a smaller diameter gear (first gear member 71 and second eccentric gear portion 76) to a larger diameter gear (first eccentric gear portion 75, and second gear member 72), thereby reducing the possibility of locking between involute gears.

FIG. 10 shows another embodiment, similar to the embodiment of FIG. 7, except that it includes a second gear member 82, which is an internal gear member fixed to the gearbox casing 83. An eccentric gear arrangement 84 includes a first external eccentric gear portion 85, which is driven by a first gear member 81, and is coupled for rotation with a second external eccentric gear portion 86, which engages the fixed second gear member 82. The eccentric gear arrangement 84 rotates on an eccentric axis defined by a crank arm 87 linked to an output shaft 88 and is balanced by a counterbalance weight 89.

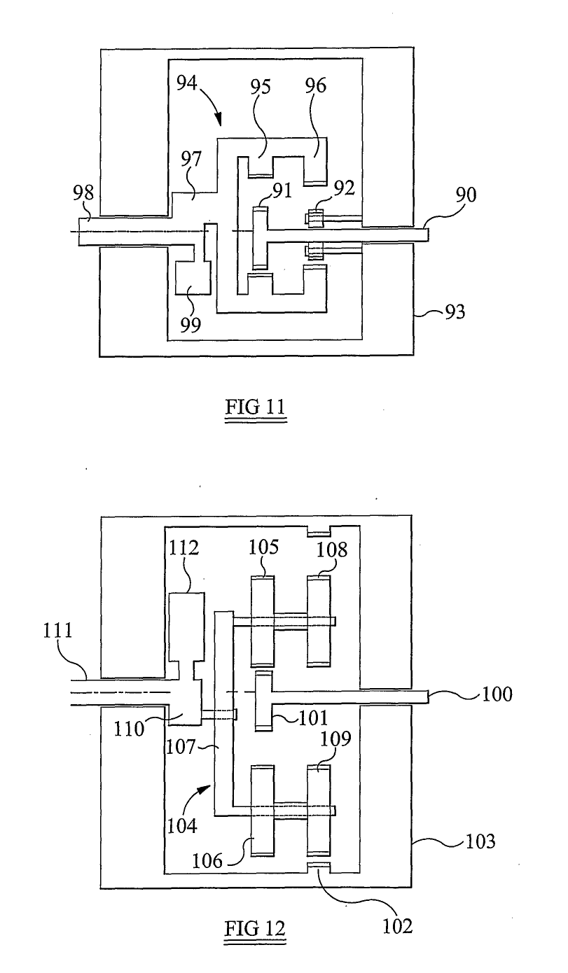

FIG. 11 shows yet another embodiment, in which an eccentric gear arrangement 94 includes first and second internal gear portions 95, 96. The first internal eccentric gear portion 95 is driven by a first gear member 91, and is coupled for rotation with the second internal eccentric gear portion 96, which engages a fixed second gear member 92. The eccentric gear arrangement 94 rotates on an eccentric axis defined by a crank arm 97 linked to an output shaft 98 and is balanced by a counterbalance weight 99.

In both the embodiments of FIGS. 10 and 11, the second gear member 82; 92, may be free to rotate, or may be driven.

FIG. 12 illustrates another embodiment, similar to the arrangement shown in FIG. 10 in that it includes a second gear member 102, which is an internal gear member fixed to the gearbox casing 103. An eccentric gear arrangement 104 includes a pair of first planet gears 105, 106 on a carrier 107. A second pair of planet gears 108, 109 are each coupled for rotation with a respective one of the first planet gears 105, 106. The first planet gears 105, 106 include a driven first planet gear 105, which is driven by a first gear member 101, coupled to an input shaft 100, and an un-driven first planet gear 106. The undriven first planet gear 106 is coupled for rotation with an engaging second planet gear 109, which engages the fixed second gear member 102. The driven first planet gear 105 is coupled for rotation with a disengaged second planet gear 109. The eccentric gear arrangement 104 rotates on an eccentric axis defined by a crank arm 110 linked to an output shaft 111.

An advantage of the arrangement of FIG. 12 is that the symmetry provided by the pairs of planet gears offers both stability and ease of balancing. It will be appreciated that the planet gears that do not engage another gear could be replaced by appropriate balance masses. It will also be appreciated that more than two planet gears may be provided, preferably equi-spaced around the carrier (i.e. 3 planets spaced at 120 degrees to each other, or 4 planets at 90-degrees etc.).

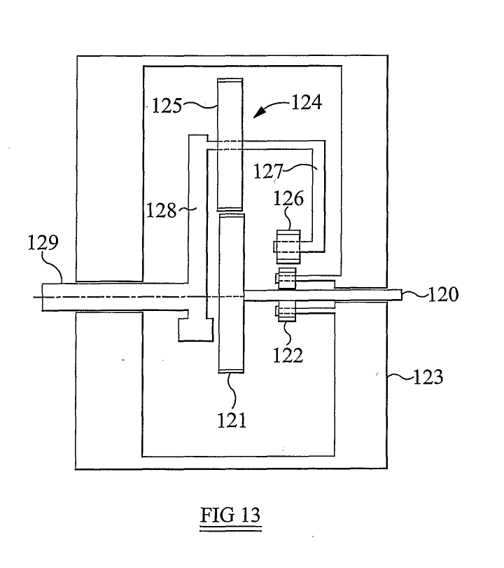

FIG. 13 illustrates another embodiment, similar to the arrangement shown in FIGS. 8 and 9. Second gear member 122, is an external gear member fixed to the gearbox casing 123. An eccentric gear arrangement 124 includes a first external eccentric gear portion 125, which is driven by a first external gear member 121. A second external eccentric gear member 126 is mounted on a crank extension arm 127. The eccentric gear arrangement 124 rotates on an eccentric axis defined by a crank arm 128 linked to an output shaft 129.

In both the embodiments shown in FIGS. 12 and 13, the eccentric gear portions, or planet gears that engage the first and second gear members, are coupled to each other by means of either the carrier 107 (FIG. 12 embodiment) or the crank extension arm 127 (FIG. 13 embodiment). Although this is not a rigid or direct coupling, as in other embodiments, the effect of the carrier/crank extension arm is the same as if the two eccentric gear portions were directly coupled. This is because, in each case, an input drive to the first eccentric gear portion via the first gear member, which produces rotation of the first eccentric gear portion, directly results in a rotation of the second eccentric gear portion, which is defined by the engagement of the second eccentric gear portion with the second gear member.

1.-47. (canceled)

48. A rotary transmission system for a speed increaser comprising:
a first transmission shaft with a crank, the first transmission shaft comprising a first rotationally coupled gear portion of at least two gears;
a first transmission shaft gear, which is part of the rotationally coupled gear portion, and a second gear member,
the first transmission shaft gear and the second gear member being mounted to engage each other eccentrically; and
a second transmission shaft comprising a third gear engaging a second rotationally coupled gear portion on the first transmission shaft, the second gear member and the third gear being rotationally independent of each other, and the second transmission shaft rotating with a high ratio in accordance with Ferguson's paradox, the Ferguson paradox rotation being a function of the constraints of all the engaging gears.

49. A rotary transmission system for a speed increaser according to claim 48, comprising at least three gear portions which are mounted to a crank, at least two of the gear portions being coupled for rotation with each other and a third gear portion being mounted to move independently with respect to the other gear portions.

50. A rotary transmission system for a speed increaser according to claim 48, wherein the second gear engaged by the first transmission shaft is driven by an external servo or drive at a fixed speed or variable speed.

51. A rotary transmission system for a speed increaser according to claim 50, wherein the servo or drive engages the first transmission shaft or the second transmission shaft.

52. A rotary transmission system for a speed increaser according to claim 50, wherein the servo or drive is mounted on a cam to maintain a drive throughout an orbital motion of an external gear portion.

53. A rotary transmission system for a speed increaser according to claim 48, wherein the system comprises a balancing means comprising a mass attachable to a gear or a cut-out from a gear.

54. A rotary transmission system for a speed increaser according to claim 48, further comprising a balancing means comprising a third gear portion engaging the first transmission shaft and mounted for rotation about an offset axis.

55. A rotary transmission system for a speed increaser according to claim 48, further comprising a balancing means comprising a third gear portion engaging the second transmission shaft and mounted for rotation about an offset axis.

56. A rotary transmission system for a speed increaser according to claim 48, wherein a plurality of gear portions are coupled by a ratchet mechanism such that the two gear portions are coupled for rotation in a first direction and are free to rotate relative to one another in a second opposite direction.

57. A rotary transmission system for a speed increaser according to claim 48, wherein the second gear member has one more gear tooth than the third gear and the second rotationally coupled gear portion on the first transmission shaft has one more gear tooth than the first rotationally coupled gear portion on the first transmission shaft, thereby achieving a high compound ratio in accordance with Ferguson's paradox between the first and second transmission shafts.

58. A rotary transmission system for a speed increaser according to claim 48, wherein the second gear member has at least two more gear teeth than the third gear and the second rotationally coupled gear portion on the first transmission shaft has at least two more gear teeth than the first rotationally coupled gear portion on the first transmission shaft, thereby achieving a high compounded ratio in accordance with Ferguson's paradox between the first and second transmission shafts.

59. A rotary transmission system for a speed increaser according to claim 48, wherein the second gear member is fixed relative to a body containing the rotary transmission system.

60. A rotary transmission system for a speed increaser according to claim 48, wherein the second gear member is free to rotate.

61. A rotary transmission system for a speed increaser according to claim 48, wherein the second gear member has a profile which meshes with the corresponding profile of the first rotationally coupled gear portion of the first transmission shaft, and the third gear has a profile which meshes with the corresponding profile of the second rotationally coupled gear portion of the first transmission shaft.

62. A rotary transmission system for a speed increaser according to claim 48, wherein the number of profiles or teeth of each of the gear portions and gear members are disposed to provide a predetermined speed increase ratio.

63. A rotary transmission system for a speed increaser according to claim 48, wherein the rotary transmission system is the drive mechanism of a wind turbine.
